(19) United States
(12) Patent Application Publication
(10) Pub. No.: US 2016/0188290 A1
(43) Pub. Date: Jun. 30, 2016

(54) METHOD, DEVICE AND SYSTEM FOR PUSHING AUDIO

(71) Applicant: Anhui Huami Information Technology Co., Ltd., Hefei (CN)

(72) Inventors: Hui WANG, Anhui (CN); Wang HUANG, Anhui (CN)

(21) Appl. No.: 14/976,462

(22) Filed: Dec. 21, 2015

(30) Foreign Application Priority Data
Dec. 30, 2014 (CN) 201410850490.4
Dec. 30, 2014 (CN) 201420866666.0

(51) Int. Cl. G06F 3/16; G06F 3/01

(52) U.S. Cl. CPC G06F 3/165; G06F 3/017

(57) ABSTRACT

Methods, devices and systems for pushing audio are set forth herein for convenient and accurate recommendation of audios to a user. The method includes receiving a user identifier and a motion status parameter associated with a user from a terminal, retrieving user data associated with the user identifier, selecting audio data based on the motion status parameter and the user data, and transmitting the selected audio data to the terminal so that an audio associated with the selected audio data can be played by the terminal. By selecting the audio based on the motion status parameter and the historical data, bases of the selection are diversified, by which results of the selection are closer to the user's needs and user experience is improved.

### CROSS-REFERENCE TO RELATED APPLICATION

This application claims priority to Chinese patent applications no. CN 201410850490.4 and no. 201420866666.0, both filed on Dec. 30, 2014, which are incorporated herein in their entireties by reference.

### TECHNICAL FIELD

The present disclosure generally relates to Internet technologies, and more particularly, to methods, devices and systems for pushing audio.

### BACKGROUND

With fast development of technologies, people are more accustomed to stay online and interact with each other via mobile Internet. Among other things, selecting music for a user can be based on, for example, listening history, preference and other related information of the user. In one example, a user during a marathon can prefer rhythmic music, but if the recommendation is based on the user's listening history and preference, other kinds of music such as slow-tempo and sad music can be recommended to the user, thus compromising the user experience.

### SUMMARY

Disclosed herein are implementations of methods, devices and systems for pushing audio.

In one aspect, the present disclosure includes a method for pushing audio comprising the steps of receiving at a computing device a user identifier and a motion status parameter associated with a user from the terminal, retrieving user data associated with the user identifier wherein the user data comprises personal data of the user and historical data of audios previously played by the user, selecting by the computing device audio data based on the motion status parameter and the user data, and transmitting the selected audio data to the terminal so that an audio associated with the selected audio data can be played on the terminal.

In another aspect, the present disclosure includes an apparatus for pushing audio to a terminal, comprising a reception module configured to receive, from the terminal, a user identifier and a motion status parameter associated with a user, a register, connected to the reception module, configured to retrieve user data associated with the user identifier received by the reception module, wherein the user data comprises personal data of the user and historical data of audios previously played by the user, a selection module, connected to the reception module and the register, configured to select audio data based on the motion status parameter received by the selection module and the user data retrieved by the register, and a transmission module, connected to the selection module, configured to transmit the audio data selected by the selection module to the terminal so that an audio associated with the selected audio data can be played on the terminal.

In another aspect, the present disclosure includes a device comprising an identification module that identifies a motion status parameter associated with a user, wherein the motion status parameter comprises a current motion status of the user and a characteristic parameter of the current motion status, and a transmission module, connected to the identification module, that transmits, to a terminal, the motion status parameter and a user identifier of the user.

In another aspect, the present disclosure includes a system comprising a server, a terminal and a wearable device. The wearable device comprises an identification module that identifies a motion status parameter associated with a user, wherein the motion status parameter comprises a current motion status of the user and a characteristic parameter of the current motion status, and a transmission module that transmits the motion status parameter and a user identifier to the terminal. The terminal comprises a first memory and a first processor configured to execute instructions stored in the first memory to receive from the wearable device the user identifier and the motion status parameter, transmit the motion status parameter and the user identifier to the server, receive audio data selected by the server, and play an audio associated with the selected audio data. The server comprises a second memory and a second processor configured to execute instructions stored in the second memory to receive from the terminal the user identifier and the motion status parameter, retrieve user data associated with the user identifier, wherein the user data comprises personal data of the user and historical data of audios previously played by the user, select audio data based on the motion status parameter and the user data, and transmit the selected audio data to the terminal.

The embodiments or implementations can be configured as executable computer program instructions stored in computer storages such as memory.

### BRIEF DESCRIPTION OF THE DRAWINGS

The description here makes reference to the accompanying drawings wherein like reference numerals refer to like parts throughout the several views, and where:

FIG. 1 is a flowchart of a method for pushing audio according to implementations in this disclosure;

FIG. 2 is a flowchart of a method for pushing audio according to implementations in this disclosure;

FIG. 3 is a flowchart of a method for pushing audio according to implementations in this disclosure;

FIG. 4A is a block diagram of a device for pushing audio according to some implementations;

FIG. 4B is a block diagram of a device for pushing audio according to an implementation;

FIG. 5A is a block diagram of a device for pushing audio according to some implementations;

FIG. 5B is a block diagram of a device for pushing audio according to an implementation;

FIG. 5C is a block diagram of a device for pushing audio according to an implementation;

FIG. 6 is a block diagram of a device for pushing audio according to implementations in this disclosure;

FIG. 7 is a block diagram of a system for pushing audio according to implementations in this disclosure;

FIG. 8 is a flowchart of a method for pushing audio according to an implementation in this disclosure; and

FIG. 9 is a flowchart of a method for pushing audio according to an implementation in this disclosure.

### DETAILED DESCRIPTION

Example implementations of the present disclosure will be described below with reference to the accompanying drawings. The same numbers across the drawings set forth in the following description represent the same or similar elements, unless differently expressed. The implementations set forth in the following description do not represent all implementations or embodiments consistent with the present disclosure; on the contrary, they are only examples of apparatuses and methods in accordance with some aspects of this disclosure as detailed in the claims.

A method for pushing audio that can be used at a server is set forth according to implementations herein, to collectively use a terminal, such as a phone or a digital audio player, and a “smart” wearable device, such as a “smart” Bluetooth or wireless enabled fitness tracker module, wristband or watch, to recommend audios to be played at the terminal for the user with more convenience and accuracy. The server can be, for example, a computing device, such as a remote server or a phone.

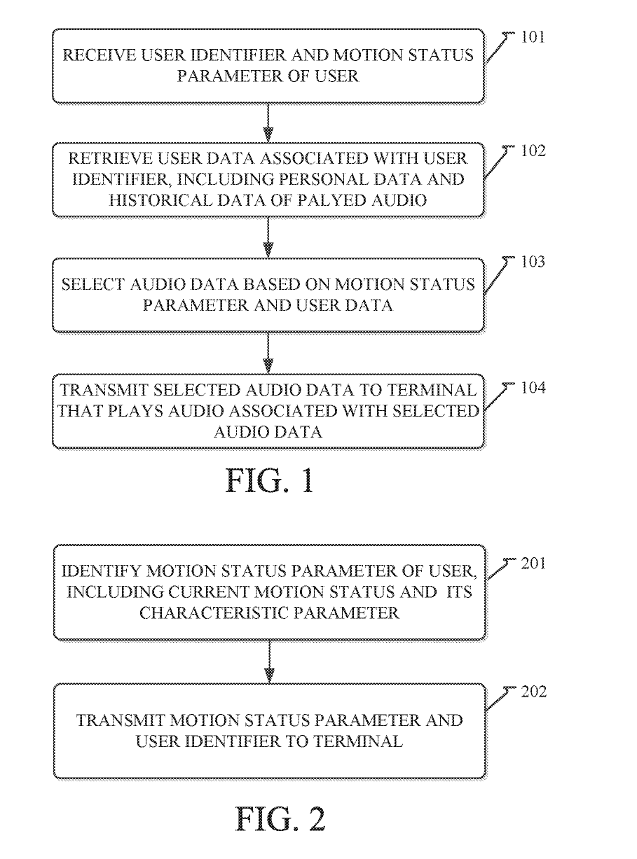

FIG. 1 is a flowchart of a method for pushing audio that is used at the computing device according to one implementation, which includes operations 101-104.

At operation 101, a user identifier and one or more motion status parameter associated with a user are received.

At operation 102, user data associated with the user identifier is retrieved. The user data can include personal data of the user and historical data of audios previously played by the user, and the personal data can include information such as age, sex, interests and so forth.

At operation 103, audio data based on the motion status parameter and the user data is selected.

At operation 104, the selected audio data is transmitted to the terminal so that an audio associated with the selected audio data can be played by the terminal.

According to this implementation, audios can be selected for the user based on the motion status parameter associated with the user (e.g., current motion status parameters of the user) and the historical data of the user. Therefore, bases of the selection are diversified, such that results of the selection are closer to the user's needs and user experience is improved. For instance, when the motion status parameter associated with the user indicates that the user is resting, the server can recommend an audio of soft and soothing rhythm to the user for relaxation; or when the motion status parameter associated with the user indicates that the user is running, with a speed of 13 kilometers per hour, the server can recommend a rhythmic audio to the user for stimulation. Therefore, by applying the method of this implementation, the audios are selected based on the motion status parameter associated with the user, by which results of the selection are closer to the user's needs.

In one implementation, at operation 101, the user identifier is stored in a wearable device that has been previously paired to the terminal via Bluetooth, and the wearable device has a function of automatically identifying the motion status parameter associated with the user. When the user wants to play audio, the wearable device transmits the user identifier and identified motion status parameter associated with the user to the terminal, then the terminal transmit them to the computing device. The motion status parameter associated with the user can include, for example, a current motion status and one or more characteristic parameters of the current motion status. For instance, the current motion status of the user can be running, sitting, climbing, cycling and so forth. In a case that the current motion status of the user is running, the characteristic parameter of the running can be, for example, one of stride rate, tempo, or speed of the running. In a case that the current motion status of the user is sitting, the characteristic parameter of the sitting can include, for example, activity specialty (e.g., a user is doing yoga or reading), and activity level such as (e.g., speed or difficulty level of yoga).

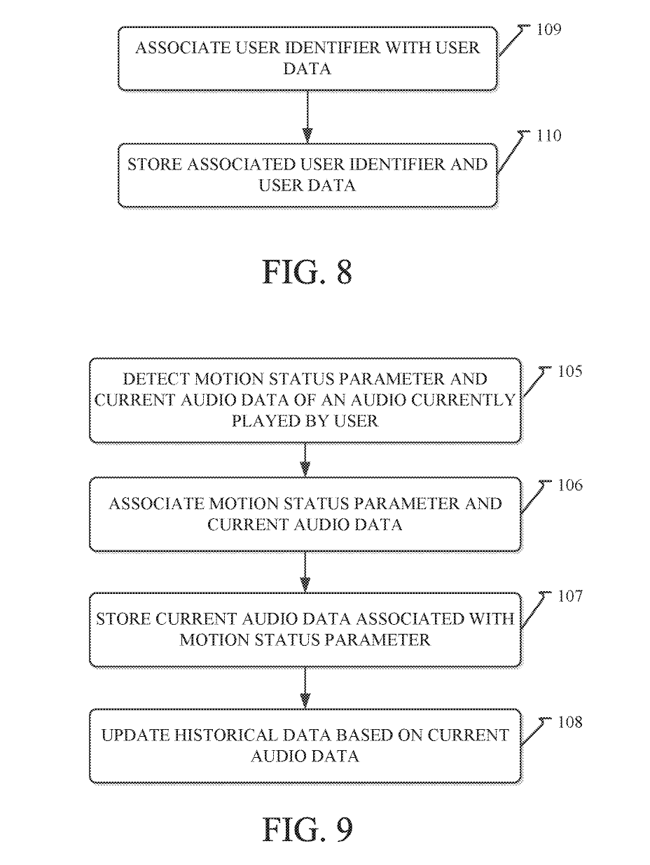

In one implementation, prior to operation 101, the aforementioned method can include operations 109-110 as set forth in the following description and illustrated in FIG. 8. At operation 109, the user identifier is associated with the user data. At operation 110, the associated user identifier and the user data are stored. Therefore, at operation 102, in response to receiving the user identifier, the computing device is able to find the user data associated with the user identifier.

At operation 103, based on the personal data of the user, the historical data (e.g., play history) associated with the personal data of the user is searched, and the audio data is selected from the historical data based on the motion status parameter associated with the user (e.g., current motion status parameters of the user).

In one implementation, after operation 104, the aforementioned method can include operations 105-108 as set forth in the following description and illustrated in FIG. 9.

At operation 105, current one or more motion status parameters associated with the user and current audio data of an audio currently played by the user are identified. Identify can include actions such as, for example, receive, retrieve, detect, record, determine and generate.

At operation 106, the motion status parameter (e.g., current motion status parameters of the user) is associated with the current audio data, such as the current play content of the user.

At operation 107, the current audio data associated with the motion status parameter is stored at a place such as the play history associated with the user data.

At operation 108, the historical data (e.g., play history) is updated based on the current audio data.

In the method of this implementation, the current audio data (e.g., play content) and the motion status parameter associated with the user (e.g., current motion status parameters) are stored as bases for next selection of an audio for the user, by which the selection of audios for the user is more accurate and closer to the user's needs and user experience is improved.

FIG. 2 is a flowchart of a method for pushing audio that can be used at a wearable device according to one implementation in this disclosure, including operations 201-202.

At operation 201, one or more motion status parameters of a user are identified, and the motion status parameters can include a current motion status and one or more characteristic parameters of the current motion status.

At operation 202, the motion status parameters and a user identifier of the user are transmitted to a terminal that transmits the motion status parameters and the user identifier to a server.

According to this implementation, the current motion status parameters of the user are automatically identified to enable the server to select audio for the user based on current motion status parameters and play history of the user (e.g., historical data of audios previously played by the user). Therefore, bases of the selection are diversified, results of the selection are closer to the user's needs and user experience is improved.

In the aforementioned method, after operation 202, the terminal transmits one or more of the motion status parameters and the user identifier to the server, which retrieves user data associated with the received user identifier including personal data and the historical data, and based on the motion status parameter associated with the user, selects audio data from the historical data and transmits the selected audio data to the terminal.

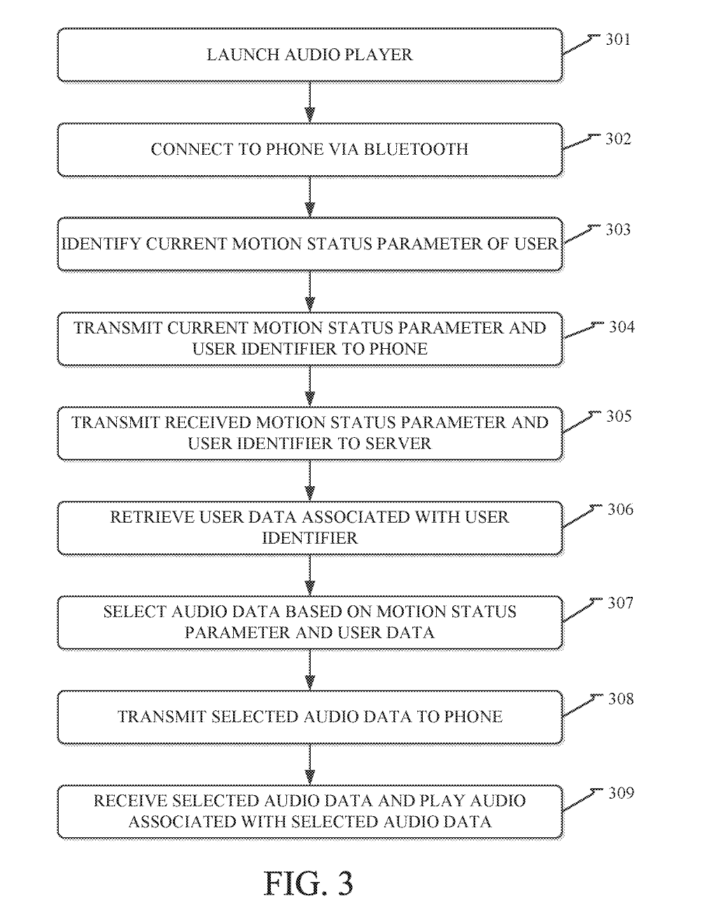

FIG. 3 is a flowchart of a method for pushing audio according to one implementation in this disclosure. In this implementation, the wearable device can be a “smart” wristband, bracelet, or watch, the terminal can be a phone, and the computing device is a server. The “smart” wristband that stores a user identifier of a user has been previously paired to the phone via Bluetooth. As illustrated in FIG. 3, the method includes operations 301-309.

At operation 301, the user starts an audio player.

At operation 302, the “smart” wristband connects to the phone via Bluetooth.

At operation 303, the “smart” wristband identifies a motion status parameter associated with the user.

At operation 304, the “smart” wristband transmits the motion status parameter and the user identifier to the phone.

At operation 305, the phone transmits the received motion status parameter and the user identifier to the server.

At operation 306, the server retrieves user data associated with the user identifier, and the user data can include personal data and historical data of audios previously played by the user.

At operation 307, the server selects audio data based on the motion status parameter and the user data.

At operation 308, the server transmits the selected audio data to the phone.

At operation 309, the phone receives the selected audio data and plays an audio associated with the selected audio data.

In this method, the “smart” wristband automatically identifies the motion status parameter and transmits it to the server through the associated phone to enable the server to select audio data for the user based on the motion status parameter and the historical data, therefore, bases of the selection are diversified, results of the selection are closer to the user's needs and user experience is improved.

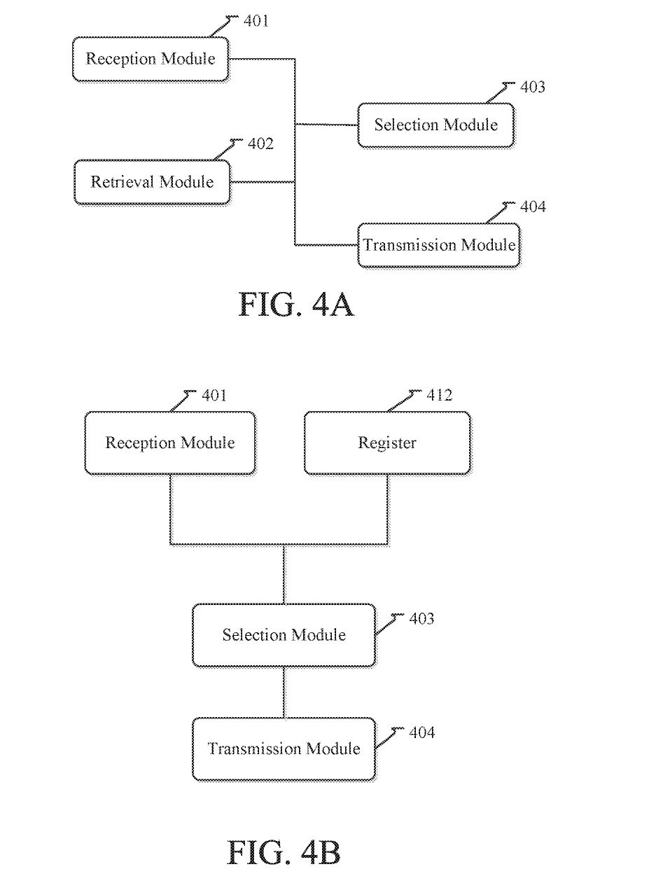

FIG. 4A is a block diagram of a device for pushing audio, such as a server, according to one implementation in this disclosure. As illustrated in FIG. 4A, the device includes modules 401-404 as set forth in the following description.

Reception module 401 receives, from a terminal associated with the device, a user identifier and one or more motion status parameters of a user.

Retrieval module 402 retrieves user data associated with the user identifier, and the user data can include personal data and historical data of audios previously played by the user.

Selection module 403 selects audio data based on the motion status parameter and the user data.

Transmission module 404 transmits the selected audio data to the terminal so that an audio associated with the selected audio data can be played on the terminal.

In one implementation, as illustrated in FIG. 4B, the aforementioned device can be configured to include modules 401-412 as set forth in the following description.

Reception module 401 receives, from the terminal, the user identifier and the motion status parameter.

Register 412, connected to reception module 401, retrieves the user data.

Selection module 403, connected to reception module 401 and register 412, selects the audio data based on the motion status parameter and the user data.

Transmission module 404, connected to selection module 403, transmits the selected audio data to the terminal.

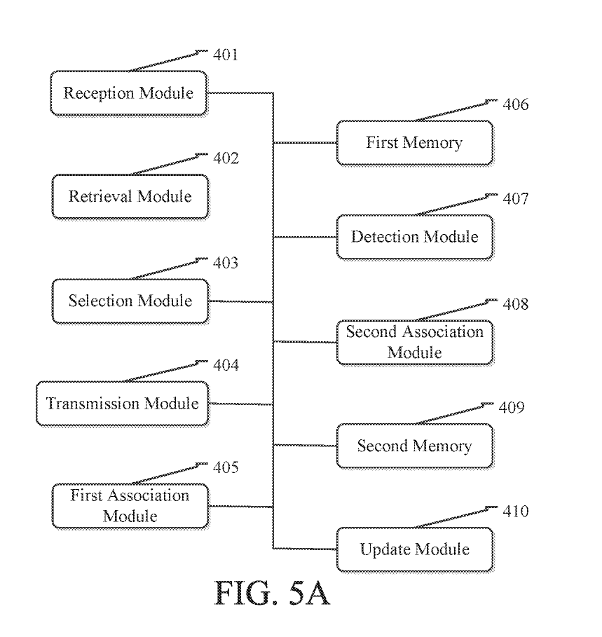

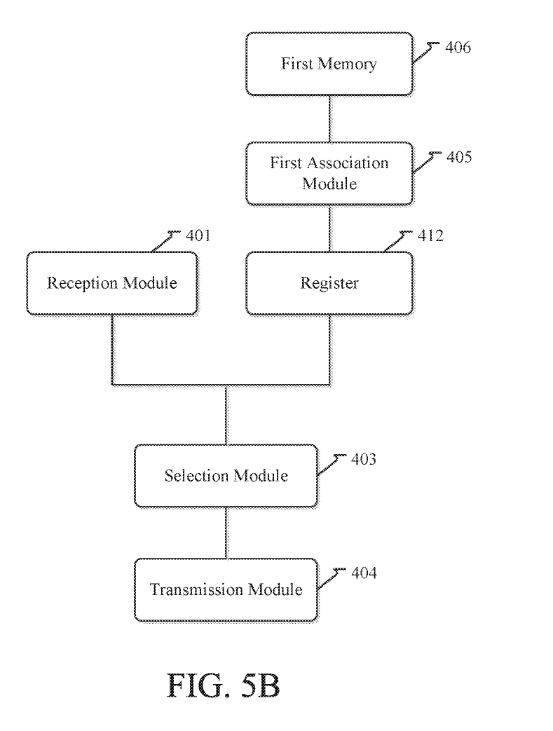

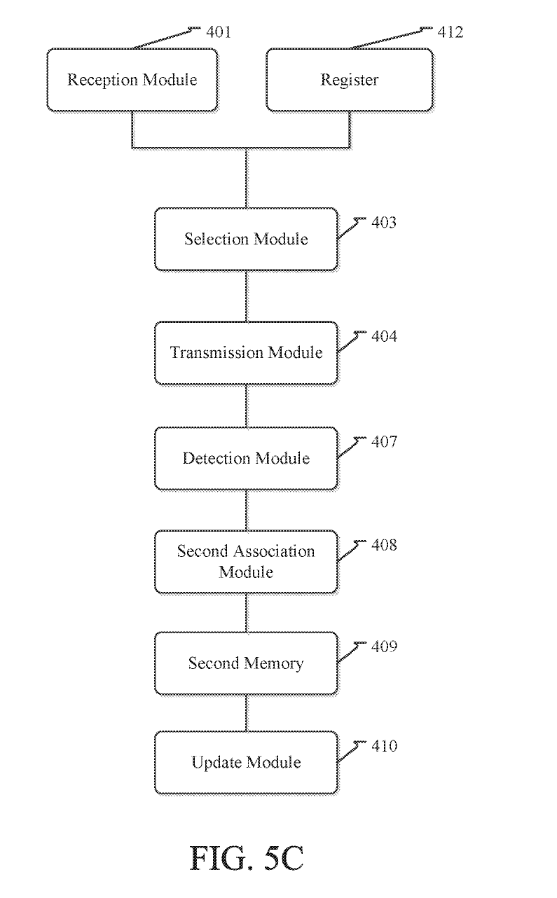

In one implementation, as illustrated in FIG. 5A, the aforementioned device can further include modules 405-410 as set forth in the following description.

First association module 405 associates the user identifier with the user data.

First memory 406 stores the associated user identifier and the user data.

Detection module 407 detects current motion status parameter and current audio data of an audio currently played by the user.

Second association module 408 associates the current motion status parameter with the current audio data.

Second memory 409 stores the current audio data associated with the current motion status parameter.

Update module 410 updates the historical data based on the current audio data.

In one implementation, as illustrated in FIG. 5B, the aforementioned device illustrated in FIG. 4B can further include modules 405 and 406 as set forth in the following description.

First association module 405, connected to register 412, associates the user identifier received from register 412 with the user data.

First memory 406, connected to first association module 405, stores the user identifier and the user data associated by first association module 405.

In one implementation, as illustrated in FIG. 5C, the aforementioned device illustrated in FIG. 4B can be further include modules 407-410 as set forth in the following description.

Detection module 407, connected to transmission module 404, detects the current motion status parameter and the current audio data.

Second association module 408, connected to detection module 407, associates the motion status parameter detected by detection module 407 with the current audio data detected by detection module 407.

Second memory 409, connected to second association module 409, stores the current audio data associated with the current motion status parameter by the second association module 409.

Update module 410, connected to second memory 409, updates the historical data based on the current audio data stored by the second memory.

According to this implementation, audios are selected for the user based on the motion status parameter (e.g., current motion status parameters) and the historical data (e.g., play history of the user), therefore, bases of the selection are diversified, results of the selection are closer to the user's needs and user experience is improved.

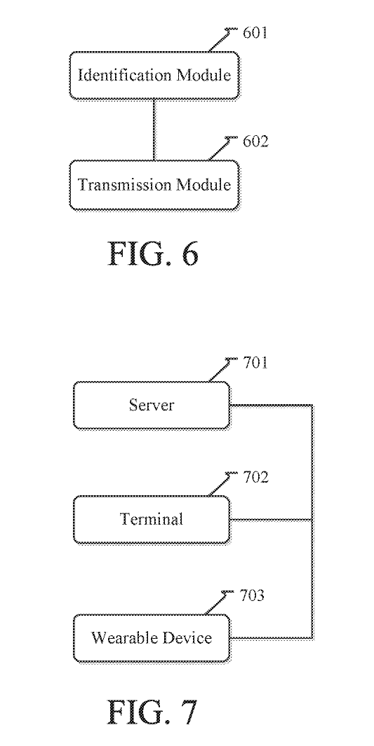

FIG. 6 is a block diagram of a wearable device, such as a “smart” wristband, for pushing audio according to one implementation in this disclosure, including modules 601-602 as set forth in the following description. Many users wear these wristbands on their wrists, some of them using the wristbands to monitor daily activities. Such a wearable device can have a button, one or more sensors such as an accelerometer or a gyroscope, and many wearable devices support connection to a terminal such as a cell phone via Bluetooth or wireless.

Identification module 601 identifies one or more motion status parameters of a user, which can include a current motion status and one or more characteristic parameters of the current motion status. The motion status parameters can be identified, for example, by a sensor such as an accelerometer or a gyroscope, or a plurality of sensors included in the wristband.

Transmission module 602 transmits the motion status parameter and a user identifier to a terminal associated with the wearable device. The terminal further transmits the motion status parameter and the user identifier to a computing device such as a server.

According to this implementation, audios are selected for the user based on the motion status parameter and the historical data of the user, therefore, bases of the selection are diversified, results of the selection are closer to the user's needs and user experience is improved.

FIG. 7 is a block diagram of a system for pushing audio according to one implementation in this disclosure. As illustrated in FIG. 7, the system for pushing audio includes server 701, terminal 702 and wearable device 703, which are detailed in the following description.

Server 701 can be configured to retrieve user data associated with the user identifier which can include personal data and historical data of audios previously played by the user, select audio data based on the motion status parameter and the user data, and transmit the selected audio data to terminal 702. Server 701 can include, for example, a memory and a processor configured to execute instructions stored in the memory to receive the user identifier and the motion status parameters from terminal 702. In some implementations, server 701 can be any device that can push audios, such as remote server computers, personal computers, cell phones, tablet computers, personal digital assistants, or a combination of one or more of the above mentioned devices.

Terminal 702 can be configured to transmit the motion status parameter and the user identifier to server 701, receive audio data selected by server 701, and play an audio associated with the selected audio data. Terminal 702 can include, for example, a memory and a processor configured to execute instructions stored in the memory to receive the user identifier and the motion status parameter from wearable device 703.

Wearable device 703 can be configured to identify one or more motion status parameters associated with a user, which can include a current motion status and one or more characteristic parameters of the current motion status, and a transmission module that transmits the motion status parameter and a user identifier to terminal 702. Wearable device 703 can include, for example, an identification module. In some implementations, the wearable device 703 can also include a memory and a processor configured to execute instructions stored in the memory to receive the user identifier and the motion status parameters identified by the wearable device.

According to this implementation, audios are selected for the user based on the motion status parameter and the historical data of the user, therefore, bases of the selection are diversified, results of the selection are closer to the user's needs and user experience is improved.

Technical specialists skilled in the art should understand that, the implementations in this disclosure can be implemented as methods, systems, or computer program products. Therefore, this disclosure can be implemented in forms of a complete hardware implementation, a complete software implementation, and a combination of software and hardware implementation. Further, this disclosure can be embodied as a form of one or more computer program products which are embodied as computer executable program codes in computer writable storage media (including but not limited to disk storage and optical storage).

This disclosure is described in accordance with the methods, devices (systems), and flowcharts and/or block diagrams of computer program products of the implementations, which should be comprehended as each flow and/or block of the flowcharts and/or block diagrams implemented by computer program instructions, and the combinations of flows and/or blocks in the flowcharts and/or block diagrams. The computer program instructions therein can be provided to generic computers, special-purpose computers, embedded computers or other processors of programmable data processing devices to produce a machine, wherein the instructions executed by the computers or the other processors of programmable data processing devices produce an apparatus for implementing the functions designated by one or more flows in the flowcharts and/or one or more blocks in the block diagrams.

The computer program instructions can be also stored in a computer readable storage which is able to boot a computer or other programmable data processing device to a specific work mode, wherein the instructions stored in the computer readable storage produce a manufactured product containing the instruction devices which implements the functions designated by one or more flows in the flowcharts and/or one or more blocks in the block diagrams.

The computer program instructions can also be loaded to a computer or another programmable data processing device to execute a series of operating procedures in the computer or the other programmable data processing device to produce a process implemented by the computer, by which the computer program instructions executed in the computer or the other programmable data processing device provide the operating procedures for the functions designated by one or more flows in the flowcharts and/or one or more blocks in the block diagrams.

Apparently, the technical specialists skilled in the art can perform any variation and/or modification to this disclosure by the principles and within the scope of this disclosure. Therefore, if the variations and modifications herein are within the scope of the claims and other equivalent techniques herein, this disclosure intends to include the variations and modifications thereof.

What is claimed is:

1. A method of pushing audio to a terminal, comprising:
receiving, at a computing device, a user identifier and a motion status parameter associated with a user from the terminal;
retrieving user data associated with the user identifier, wherein the user data comprises personal data of the user and historical data of audios previously played by the user;
selecting, by the computing device, audio data based on the motion status parameter and the user data; and
transmitting the selected audio data to the terminal so that an audio associated with the selected audio data can be played on the terminal.

2. The method of claim 1, wherein the motion status parameter comprises one or more motion status parameters.

3. The method of claim 2, wherein the motion status parameter comprises a current motion status of the user and a characteristic parameter of the current motion status.

4. The method of claim 3, wherein the current motion status comprises at least one of resting, running, sitting, climbing, cycling and doing yoga, and the characteristic parameter comprises data associated with at least one of stride rate, tempo, speed, activity specialty, and activity difficulty.

5. The method of claim 1, wherein the personal data comprises at least one of age, sex and interests of the user.

6. The method of claim 1, prior to the receiving the user identifier and the motion status parameter from the terminal, further comprises:
associating the user identifier with the user data; and
storing the associated user identifier and the user data.

7. The method of claim 1, further comprising:
detecting the motion status parameter and current audio data of an audio currently played by the user;
associating the motion status parameter with the current audio data;
storing the current audio data associated with the motion status parameter; and
updating the historical data based on the current audio data.

8. The method of claim 7, wherein the current audio data comprises the selected audio data.

9. An apparatus for pushing audio to a terminal, comprising:
a reception module configured to receive, from the terminal, a user identifier and a motion status parameter associated with a user;
a register, connected to the reception module, configured to retrieve user data associated with the user identifier received by the reception module, wherein the user data comprises personal data of the user and historical data of audios previously played by the user;
a selection module, connected to the reception module and the register, configured to select audio data based on the motion status parameter received by the selection module and the user data retrieved by the register; and
a transmission module, connected to the selection module, configured to transmit the audio data selected by the selection module to the terminal so that an audio associated with the selected audio data can be played on the terminal.

10. The apparatus of claim 9, further comprising:
a first association module, connected to the register, configured to associate the user identifier retrieved by the register to the user data; and
a first memory, connected to the first association module, configured to store the user identifier and the user data associated by the first association module.

11. The apparatus of claim 9, further comprising:
a detection module, connected to the transmission module, configured to detect the motion status parameter and current audio data of an audio currently played by the user;
a second association module, connected to the detection module, to associate the motion status parameter with the current audio data;
a second memory, connected to the second association module, configured to store the current audio data associated with the motion status parameter; and
an update module, connected to the second association module, configured to update the historical data based on the current audio data.

12. A wearable device for pushing audio to a terminal, comprising:
an identification module configured to identify a motion status parameter associated with a user, wherein the motion status parameter comprises a current motion status of the user and a characteristic parameter of the current motion status; and
a transmission module, connected to the identification module, that transmits, to the terminal, the motion status parameter and a user identifier of the user.

13. The wearable device of claim 12, wherein the identification module comprises one or more sensors.

14. The wearable device of claim 13, wherein the one or more sensors further comprise at least one of an accelerometer and a gyroscope.

15. The wearable device of claim 12, wherein the current motion status comprises running, and the characteristic parameter comprises at least one of stride rate, tempo, and speed.

16. The wearable device of claim 12, wherein the current motion status comprises sitting, and the characteristic parameter comprises data associated with at least one of activity specialty and activity difficulty.

17. A system for pushing audio, comprising:
a wearable device, comprising:
an identification module that identifies a motion status parameter associated with a user, wherein the motion status parameter comprises a current motion status of the user and a characteristic parameter of the current motion status; and
a transmission module that transmits the motion status parameter and a user identifier to a terminal associated with the wearable device;
a terminal, comprising:
a first memory; and
a first processor configured to execute instructions stored in the second memory to:
receive, from the wearable device, the user identifier and the motion status parameter;
transmit the motion status parameter and the user identifier to a server associated with the terminal;
receive audio data selected by the server; and
play an audio associated with the selected audio data; and
a server, comprising:
a second memory; and
a second processor configured to execute instructions stored in the first memory to:
receive, from the terminal, the user identifier and the motion status parameter;
retrieve user data associated with the user identifier, wherein the user data comprises personal data of the user and historical data of audios previously played by the user;
select audio data based on the motion status parameter and the user data; and
transmit the selected audio data to the terminal.
